(19) United States
(12) Patent Application Publication
(10) Pub. No.: US 2011/0021069 A1
(43) Pub. Date: Jan. 27, 2011

(54) THIN FORMAT CRUSH RESISTANT ELECTRICAL CABLE

(76) Inventors: Yiping HU, San Diego, CA (US); Qihua Weng, San Diego, CA (US); Lance Weeks, San Diego, CA (US)

Correspondence Address: ARC PATENTS, 7910 IVANHOE AVE. #325, LA JOLLA, CA, 92037, US

(21) Appl. No.: 12/705,479

(22) Filed: Feb. 12, 2010

Related U.S. Application Data
(60) Provisional application No. 61/227,365, filed on Jul. 21, 2009.

(51) Int. Cl. H01B 9/02; H01R 9/05

(52) U.S. Cl. 439/578; 174/107; 174/106 R

(57) ABSTRACT

A thin format crush resistant electrical cable that includes at least one bundle, having each bundle comprising a central conductor, an insulator that encapsulates the central conductor, a shielding that encapsulates the insulator, and a jacket that encapsulates the shielding wherein the jacket is crush resistant and thin format in cross section wherein a height of the jacket is smaller than a width of the jacket in cross-section and which enables a small bending radius. One or more embodiments include a small coaxial cable with width less than the jacket height in which the coaxial cable resides. Additional form fitting elements may be utilized as one or more additional bundles to provide for direction changes of the cable that may be implemented by bending the cable wherein the form fitting elements or wires maintain the form desired. The additional bundles may be conductive wire in any geometry.

This application claims the benefit of U.S. Provisional Patent Application Ser. No. 61/227,365 filed 21 Jul. 2009, the specification of which is hereby incorporated herein by reference.

### BACKGROUND OF THE INVENTION

1. Field of the Invention

One or more embodiments of the invention are related to the field of electrical cables. More particularly, but not by way of limitation, one or more embodiments of the invention enable a thin format crush resistant electrical cable.

2. Description of the Related Art

Standard coaxial cables may be utilized to connect high frequency electronic components together. For example, coaxial cables may be utilized to connect antennas or cable boxes to televisions. This presents a problem when the coaxial cable must traverse from the outside of a house to the inside of a house for example. A hole may be drilled through the exterior of the house in order to feed the coaxial cable to the inside of the house. The hole in the house may lead to a multitude of problems, for example with respect to moisture that may enter through the hole. In addition, running the coaxial cable through the house causes lumps in the carpet for example when the coaxial cable is not embedded or directed through the ceilings and walls of the house. Coaxial cables that are directed under carpet may be crushed over time, for example through repeated walking on, or movement of heavy appliances or furniture over the cable, e.g., on a dolly with narrow wheels.

With respect to the coaxial cable functionality itself, in the field of signal transmission line design, it is often desirable to achieve a broad bandwidth (cover from DC to 3 GHz) and a low transmission loss when connecting electrical components. Example parameters associated with the transmission line are characteristic impedance and the transmission loss. The characteristic impedance is given by the conductor's diameter, the dielectric permittivity of the materials involved, shield and braiding size. The transmission loss is determined mainly by the conductor material, conductor's diameter, dielectric loss tangent of the materials involved. There are some essential rules between these parameters: the impedance of transmission line is inversely proportional to the characteristic capacitance; the width of the signal line can be decreased to raise the characteristic inductance and thereby raise the characteristic impedance. Wider signal line diameter results in both decreased losses and lower characteristic impedance. The filled material between the signal line and the shield are often chosen for example from foam PE for a higher characteristic impedance. In some transmission lines the characteristic impedance can be raised to a maximum value by adjusting the distance between a signal strip and shielding. Regardless of the physical makeup of the coaxial cable, once a desired impedance is selected based on the parameters utilized, it is desirable to protect the dielectric for example from being crushed so as to maintain the impedance of the coaxial cable.

U.S. Pat. No. 7,314,998, filed 10 Feb. 2006, to Amato et al., relates to a flat coaxial jumper device, for example that may be utilized as a jumper cable that can be passed through a window sill or a door. The jumper may not be not durable in that the jacket is thin and hence does not protect the conductor, dielectric or shielding sufficiently. The jumper also utilizes a simple oval dielectric and correspondingly large copper shield that is costly and for at least this reason, the jumper is meant to be utilized over a very short distance, most preferably 6-7 inches, and not for example underneath a long stretch of carpet for example. In addition, the jumper is not designed to bend as the jumper is meant to be positioned on a flat surface without a change of direction, hence the bending radius is of the jumper is large in the vertical axis and very large in the horizontal axis. Also, the oval shield may be difficult to terminate on the ground of the connector in order to minimize noise ingress. For at least the limitations described above there is a need for a thin format crush resistant electrical cable.

### BRIEF SUMMARY OF THE INVENTION

One or more embodiments described in the specification are related to a thin format crush resistant electrical cable. The cable includes a small cylindrical bundle that comprises a central conductor, an insulator encapsulating the central conductor, and shielding encapsulating the insulator. A jacket encapsulates the cylindrical bundle. The height of the jacket is smaller than the cross-sectional width of the jacket. For example, the ratio of the height to the width of the cable may include any number less than 1, with common embodiments ranging from ⅓ and 1/10. This allows for the thin format crush resistant electrical cable to fit under a window in a windowsill for example. In addition, this allows the cable to be threaded under existing carpet without requiring holes to be drilled in walls or without requiring running the cable through the ceiling and walls. The small cylindrical bundle allows for an exceptionally small bending radius.

Embodiments of the thin format crush resistant cable may contain more than one cylindrical bundle, each cylindrical bundle may include an inner or central conductor, an insulator or dialectric that encapsulates the central conductor, and shielding that encapsulates the insulator. A jacket encapsulates the one or more cylindrical bundles.

In each cylindrical bundle, the inner or central conductor, the insulator and the shielding may be concentrically aligned or arranged in any other geometry or alignment so long as the desired impedance of the cable is achieved. The shielding may comprise a foil shield layer, a braiding layer, both a foil shield layer and a braiding layer, or multiple foil shield layers and braiding layers.

The thin format crush resistant electrical cable may further comprise a strip of conductive material and at least one end connector coupled with the strip of conductive material, wherein the shielding at one end of the cable is also coupled with the strip of conductive material. In this manner, the thin format crush resistant electrical cable may be terminated to a standard end connector of any type.

The thin format crush resistant electrical cable may further include a second conductive layer that includes either a larger strip of conductive material or a conductive shrink-wrap and at least one end connector coupled with the conductive shrink-wrap wherein the shielding at one end of the cable is also coupled with the conductive shrink-wrap. Any type of conductive shrink-wrap, for example plastic with embedded metallic particulars or threads may be utilized. This forms a second type of noise protected termination allowing for any type of end connector to be coupled to the cable.

### BRIEF DESCRIPTION OF THE DRAWINGS

The above and other aspects, features and advantages of the invention will be more apparent from the following more particular description thereof, presented in conjunction with the following drawings wherein:

FIG. 1 illustrates a plan view of one or more embodiments of the cable.

FIG. 2 illustrates a cross-sectional view of one or more embodiments of the cable at plane A-A.

FIG. 3 illustrates a cross-sectional view of one or more embodiments of the cable.

FIG. 4 illustrates a graph of simulated return loss for one or more embodiments of the cable.

FIG. 5 illustrates a graph of simulated transmission loss for one or more embodiments of the cable.

FIG. 6 illustrates a connector that is prepared for coupling with cable shielding via a file utilized to mark/rough the cylindrical end portion of the connector.

FIG. 7 illustrates the stripped cable with braiding bent back and the conductor as inserted into connector.

FIG. 8 illustrates the cable braiding as placed over connector in preparation for coupling with the connector.

FIG. 9 illustrates the connector rotated and braiding placed all the way around the connector in final preparation for coupling with the connector.

FIG. 10 illustrates a small strip of conductive shielding to be utilized in coupling the braiding with the connector.

FIG. 11 illustrates the small strip of conductive shielding as wrapped around the braiding that is in contact with the connector.

FIG. 12 illustrates the small strip of conductive shielding as soldered to the connector, therein binding the braiding to the connector.

FIG. 13 illustrates the small strip of conductive shielding as soldered in a perspective view.

FIG. 14 illustrates a larger strip of conductive shielding to be utilized to shield remainder of the braiding.

FIG. 15 illustrates the larger strip of conductive shielding wrapped around the braiding and small conductive shielding.

FIG. 16 illustrates the connector rotated and the larger strip of shielding as placed all the way around the connector.

FIG. 17 illustrates the larger strip of conductive shielding as covered with insulative material.

FIG. 18 illustrates a side view of the cable bent over itself, therein enabling a 180 degree bending radius for one or more embodiments of the invention.

### DETAILED DESCRIPTION OF THE INVENTION

A thin format crush resistant electrical cable will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

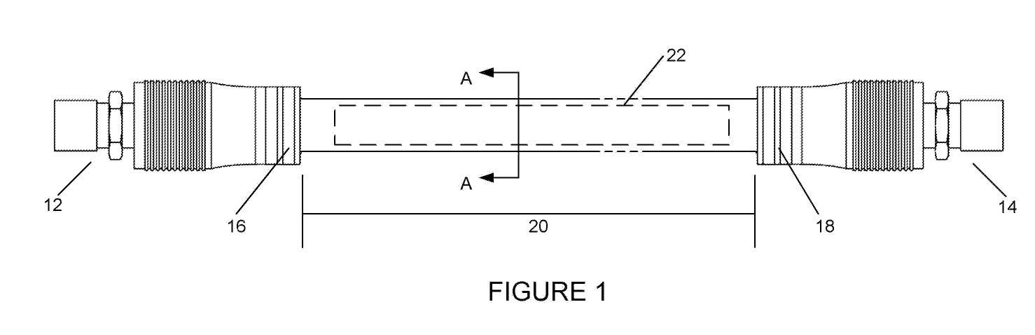

FIG. 1 shows embodiment of cable 20, implemented as a thin format crush resistant electrical cable having two cable ends 16 and 18. Cable 20 is optionally secured by optional adhesive layer 22 to a substantially flat installation surface such as a windowsill, doorframe, flooring, or any other substantially flat structural surface. Embodiments of the invention may be implemented with internal cables or wires that allow for cable 20 to bend in any direction without damaging the internal cables or wires however. Optional adhesive layer 22 may include glue, tape, film adhesives, polymer adhesives, curing adhesives, or any other compound capable of permanently or removably coupling cable 20 to a surface including a substantially flat installation surface. The optional adhesive layer may be provided on a broad surface of cable 20 or may be applied to a broad surface of cable 20 during installation of cable 20. Alternatively, cable 20 is free standing or secured in any other manner. Cable ends 16 and 18 may be terminated with connectors 12 and 14 although this is not required. Connector 12 or 14 may be male connector, female connector, or any other connector that provides an electrical connection between a cable end and an electrical device or input. The length of cable 20 can be any distance as the cable is relatively inexpensive to manufacture based on the small size of the electromagnetic transmission elements embedded in cable 20 and is not limited for example to a small distance for use as a jumper.

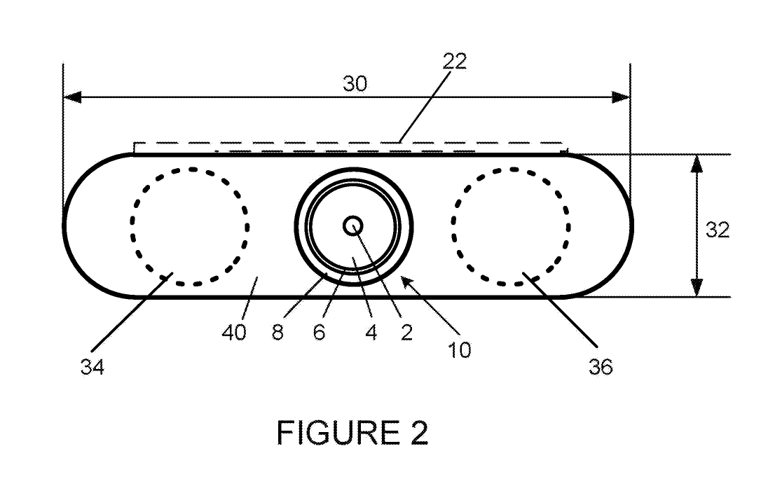

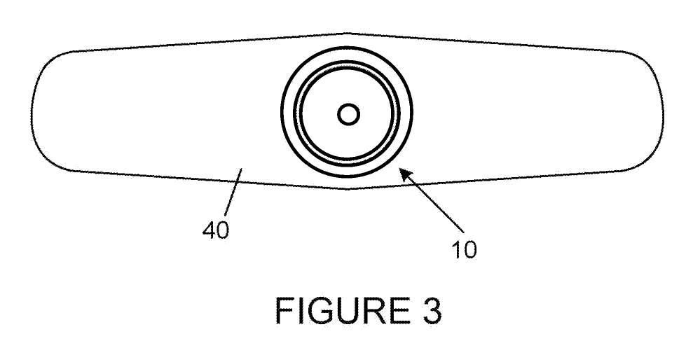

FIG. 2 shows a cross-sectional view of cable 20 FIG. 1 at the A-A plane. The cross-sectional width 30 and thickness or height 32 of cable 20 distinguish the thin format crush resistant cable from traditional coaxial cables. The width of the thin format cable is generally greater than, i.e., for example large relative to the height, i.e., thickness. The ratio of height 32 to width 30 ranges from any number less than 1 and may form commonly utilized embodiments that may for example be configured with a height 32 to width 30 ratio of ⅓ or 1/10 or lower. The height 32 for example in one or more embodiments may be ⅛″ (3.18 mm) or less although this is not required. In one or more embodiments of the thin format crush resistant cable, the width may be 10±0.5 mm and the height may be 2.8±0.1 mm. Other embodiments of the cable may include any other width or height that are not equal as is the case with round coaxial cables for example. The top surface of the cable and the bottom surface of the cable may be flat and parallel as shown in FIG. 2. FIG. 3 shows a cross-sectional view of an exemplary embodiment of the thin format cable where the top surface of the cable and the bottom surface of the cable are neither flat nor parallel, but wherein the overall height to width ratio is maintained at less than 1.

As per FIG. 2, cable 20 comprises bundle assembly 10 encapsulated by non-round jacket 40. Bundle assembly 10 may be implemented in a format much smaller than a typical standard coaxial cable in one or more embodiments of the invention through proper choice of dielectric for example. Bundle assembly 10 may be substantially cylindrical and is aligned with a central axis running down the length of the cable, i.e., perpendicular to the printed page. Bundle assembly 10 comprises central conductor 2, insulator 4 (i.e., a dielectric generally) and a shielding comprising foil shield 6 and braiding 8. The central conductor 2, insulator 4, foil shield 6 and braiding 8 may be arranged concentrically, or in any other geometrical configuration so long as the height to width ratio of jacket 40 is less than 1. In one or more embodiments, the thickness of bundle assembly 10 in width is less than the height of jacket 40. In one or more embodiments, bundle assembly 10 may be round or any other shape that is small enough to allow for a bending radius as small as the width or even as small as the height of cable 20. In one or more embodiments, utilizing relatively small coaxial bundle assemblies with respect to the width of jacket 40, allows for jacket 40 to take the brunt of an external downward force, wherein jacket 40 resists the crushing force so that the bundles assemblies do not. This gives the cable a high resistance to crushing forces, while the small inner bundle assembly allows for a very small bending radius.

In one or more embodiments, central conductor 2 is positioned at the core of bundle assembly. Central conductor 2 is formed from a conductive material, such as copper, a copper-clad metal, or any other conductive metal or alloy. Insulator 4 concentrically surrounds central conductor 2. Insulator 4 may be formed from a dielectric, such as taped, solid or foamed polyoefins and fluropolymers, or any other suitable solid non-conducting substance. The shielding of bundle assembly 10 comprises conductive materials configured to provide electromagnetic shielding to prevent electromagnetic interference and radio frequency interference. Typical shielding used in coaxial cables include foil shields, braiding, or a combination thereof. Multiple layers of foil shield and braiding may be used.

Jacket 40 encapsulates bundle assembly 10. Jacket 40 is formed from a non-conductive or semi-conductive compounds, such as PVC, plastic, Teflon, PVDF, KYNAR®, PU, polyethylene, or other compounds typically used to jacket cables. Preferably, jacket 40 comprises a material capable of protecting encapsulated bundle assembly 10 given factors including but not limited to bundle assembly size, bundle assembly composition, cable width 30, cable thickness 32, environmental factors in an installation environment. The color of cable 20 comprises a natural color of the material forming jacket 40 or a dye mixed with the material. Alternatively, cable 20 may be painted or otherwise covered with a material of a desired color. Additional markings may be impressed, printed or otherwise added to the exterior of cable 20.

Optionally, additional bundle assemblies 34 and 36 are encapsulated in jacket 40. Each additional bundle assembly comprises a standard wire or a central conductor, an insulator, and a shield arranged in the configuration described with respect to bundle assembly 10. Optional, additional bundle assemblies and other assemblies, and/or other wire structures 34 and 36 run parallel with bundle assembly 10 down the length of cable 20. If the bundle assemblies are implemented in a small enough size, then the bundle assemblies may run the length of the cable as twisted about one another in the case of wire assemblies or wires. Each bundle assembly may terminate in a separate connector at each respective end of the cable for example. In the case of three coaxial bundle assemblies, each end of the cable may include three coaxial connectors on each end of the cable. Any number of bundle assemblies may be utilized in the cable and may be terminated in any number of terminators less than, equal to, or greater than the number of bundle assemblies by grouping or sharing bundle assemblies per terminator. When implemented with standard wire, additional assemblies 34 and/or 36 may be used to form fit, or provide a change in direction for the cable so long as a wire is utilized (or any other material in place of wire) that retains shape once bent in a particular desired direction. For example, with one or more bundle assembly 34 or 36 implemented as at least one wire, any material may be utilized to as the wire, whether conducting or not, so long as the wire can hold a direction imparted through an external force to form fit the cable in a desired direction. In one or more embodiments the width of bundle assembly 10, 34 or 36 is less than a height that is half of the width of jacket 40, allowing for 2 or more bundle assemblies to reside within jacket 40. In other embodiments the bundle assembly is smaller than the jacket and the jacket is a non-uniform thickness. In this embodiment and in keeping with the spirit of the invention, the cross section of bundle assembly 10, 34 or 36 differs from the cross section shape of jacket 40, which enables a smaller bending radius than is currently known and allows for minimum utilization of conductive components and allows for jacket 40 to take the brunt of compressive force.

### Example 1

An exemplary thin format crush resistant cable with a cylindrical bundle assembly includes a central conductor of the cable is bare copper measuring 0.35 mm in diameter. The insulator is foam polyethelene and measures 1.6 mm in diameter, inclusive of the central conductor. The shielding includes a foil shield and braiding. Foil shield is positioned directly on the insulator and comprises “Single-side.6 mm/25U Al” aluminum. Braiding positioned directly over the foil shield comprises a “16×4×0 0.10 mm” copper clad steel. Table 1A-1D presents data from measurements and models regarding electrical, environmental and mechanical properties of a 250 mm thin format crush resistant cable as described in example 1, configured for 75 Ohm impedance.

TABLE 1A
measured electrical properties of 250 mm length of cable of Example 1
Electrical Specification

| | Specification | | | | |
|---|---|---|---|---|---|
| Item | Min. | Typ | Max. | Unit | Condition |
| Input Frequency Range | 5 | | 2150 | MHZ | |
| Insertion Loss | | 0.6 | 1.5 | dB | 5-2150 MHz |
| Flatness | | | 1.5 | dB | Full Spectrum 5-21 MHz |
| | | | 0.25 | dB | Any 25 MHz channel, 950-2150 MHz |
| | | | | | Any 6 MHz channel, 5-860 MHz |
| Return Loss | | −14 | −12 | dB | 5-2150 MHz |
| Nominal RF Impedance | | 75 | | 0 | 5-2150 MHz |
| DC Voltage Range | 10.5 | | 28 | Vdc | |
| DC Current Pass Range | 0 | | 1650 | mA | 28 Vdc |
| DC Loop Resistance | | | 0.5 | Ohms | To include frequencies up to 50 kHz |
| DC Voltage Drop | | | 0.8 | Vdc | |
| Shielding Effectiveness | 85 | | | dB | |

TABLE 1B
environmental properties of 250 mm length of cable of Example 1
Environmental Specification

| Temperature | Storage | −40° C.-+80° C. |
|---|---|---|
| | Outdoor Operating | −40° C.-+80° C. |
| | External ambient, does not include temperature | |
| | rise due solar radiation. | |
| Humidity | Operating | 95% RH @38° C. max., |
| | | non-condensing |
| | Storage | 95% RH @38° C. max., |
| | | non-condensing |

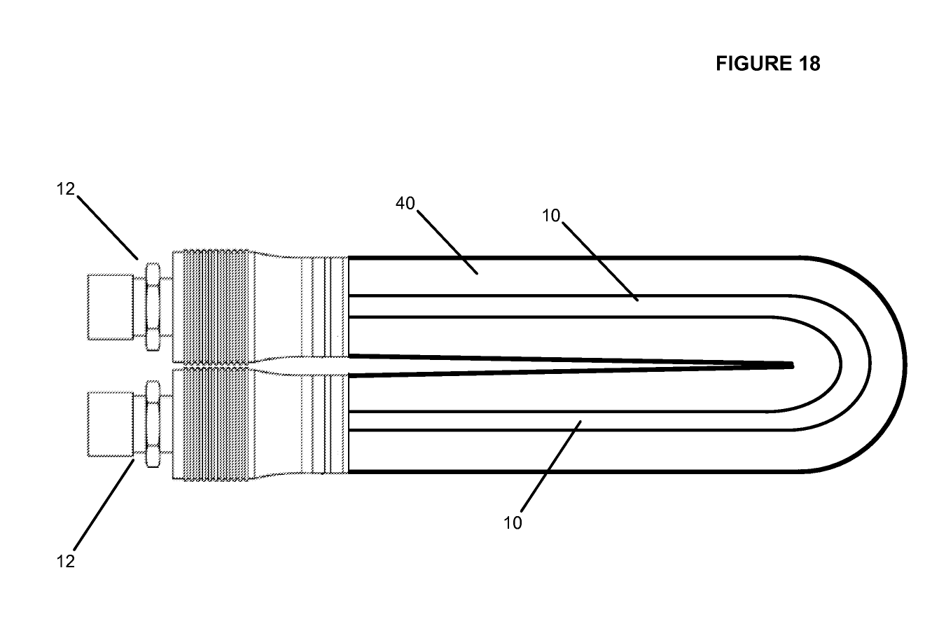

Table 1C: mechanical electrical properties of 250 mm length of cable of Example 1, note extremely small bending radius approximately equal to the height of the cable for example (as per flex requirement row). FIG. 18 illustrates a side view of the cable bent over itself, therein displaying a 180 degree bending radius for one or more embodiments of the invention. Depending on the specific application requirement, jacket 40 may be selected from a material that is pliable enough to bend 180 degrees over itself on cross-sectional width 30 (top to bottom) or even onto itself on height 32 (side to side) of cable 20 of FIG. 2. Bundle assembly 10 may be implemented in any thickness, including a small enough thickness with respect to the width 30 or height 32, so that conductor 2, insulator 4, foil shield 6 and braiding 8 will not tear or rupture when bent over on itself in any direction, including radially.

Mechanical Specification

| | |
|---|---|
| Pull Force at connections | 25-lbs in any direction |
| Flex requirement | 180 degree bend on self w/25-lbs load |
| | on bend: no electrical degradation. |
| Torque test on F connectors | Connectors shall withstand 75 in-lbs of |
| | torque. |

TABLE 1D
materials specifications of 250 mm length of cable of Example 1
Materials Specifications

| No | Description | Material | Notes |
|---|---|---|---|
| 1 | Conductor | Bare Copper | 0.35 mm |
| 2 | Insulator | Foam PE | 1.6 mm |
| 3 | Foil Shield | Al | Single-side. 6 mm/25 U |
| 4 | Braiding | CCS | 16 × 4 × 00.10 mm |
| 5 | Jacket | PVC | White |

Another embodiment of the cable may utilize materials as follows:

| | |
|---|---|
| Conductor | Bare Copper (BC) |
| Insulator | HDPE |
| Shield & Braiding | AL TCW |
| Jacket | PVC |

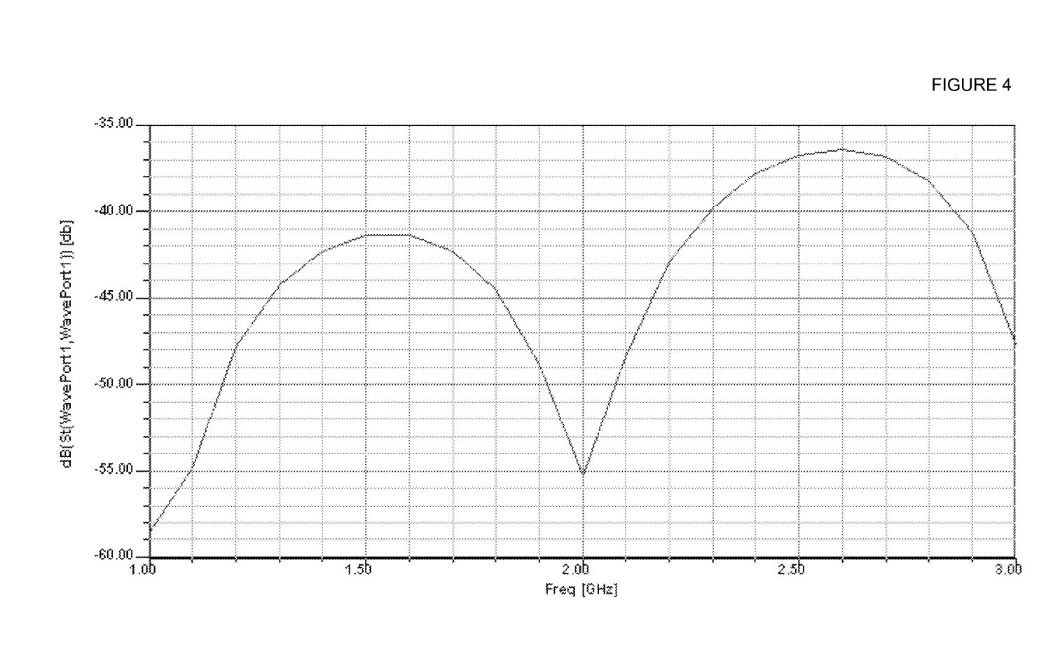

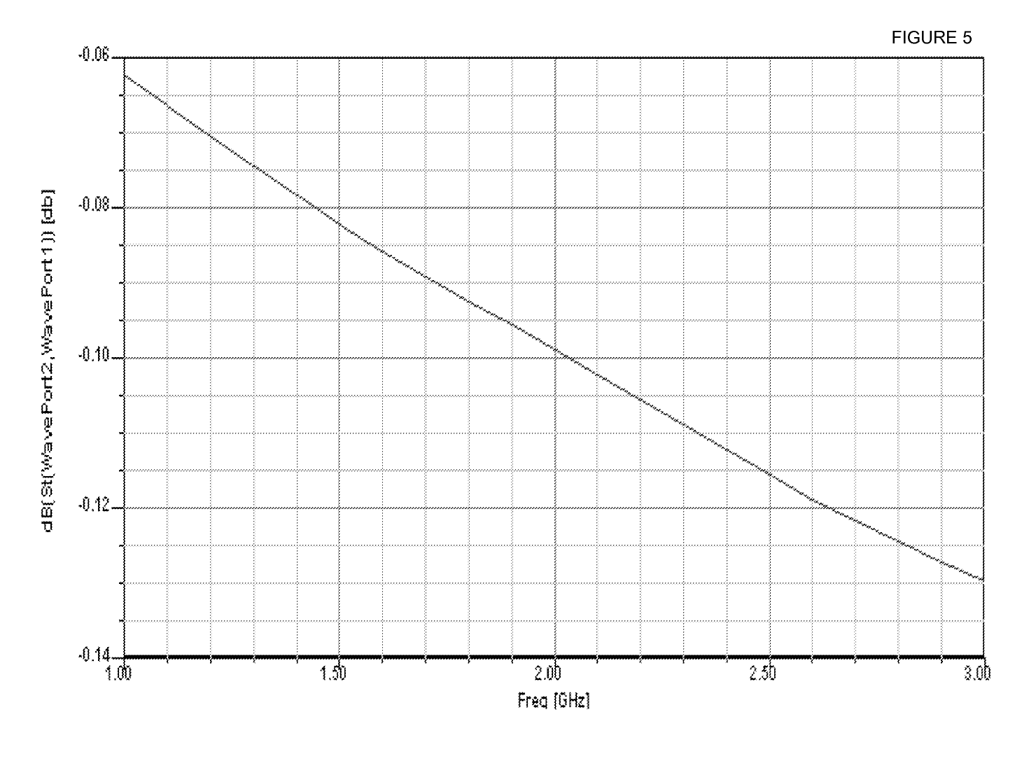

FIG. 4 presents a graph of simulated return loss for embodiments of the invention as described in FIG. 2. FIG. 5 presents a graph of simulated transmission loss for embodiments of the invention as described in FIG. 2. A simulation of a flat-cable embodiment wherein the relative dielectric permittivity value of PE is set to 2.26 and the length of the cable is set to 250 mm. When the distance between the conductor and shield is 0.98 mm, the characteristic impedance is closest to 75 Ohm.

Any type of cable terminator or connector may be utilized on the ends of the cables in keeping with the spirit of the invention.

One or more embodiments of the invention may be coupled to end connectors by stripping the jacket back, soldering the signal wire, pulling the shielding back, wrapping a copper strip around the shielding and soldering the copper strip to the connector, then soldering the copper to the shielding. Optionally, a second piece of copper in the form of a strip may be wrapped around the end connector and shielding and other strip, which is then ready to mold a plastic casing around. Optionally, any type of conductive shrink-wrap may also be utilized to form an electrical shield around the connector and shielding before molding over a casing. The casing for example may include any type of end connector such as an F type coaxial connector. Any type of connectors may be utilized with the cable embodiments described herein.

FIG. 6 illustrates connector 14 that is prepared for coupling with foil shield 6 and/or braiding 8 via a file utilized to mark/rough the cylindrical end portion of connector 14. If connector 14 comprises an area that is rough enough, then the connector may be coupled without marking or roughing the surface of connector 14.

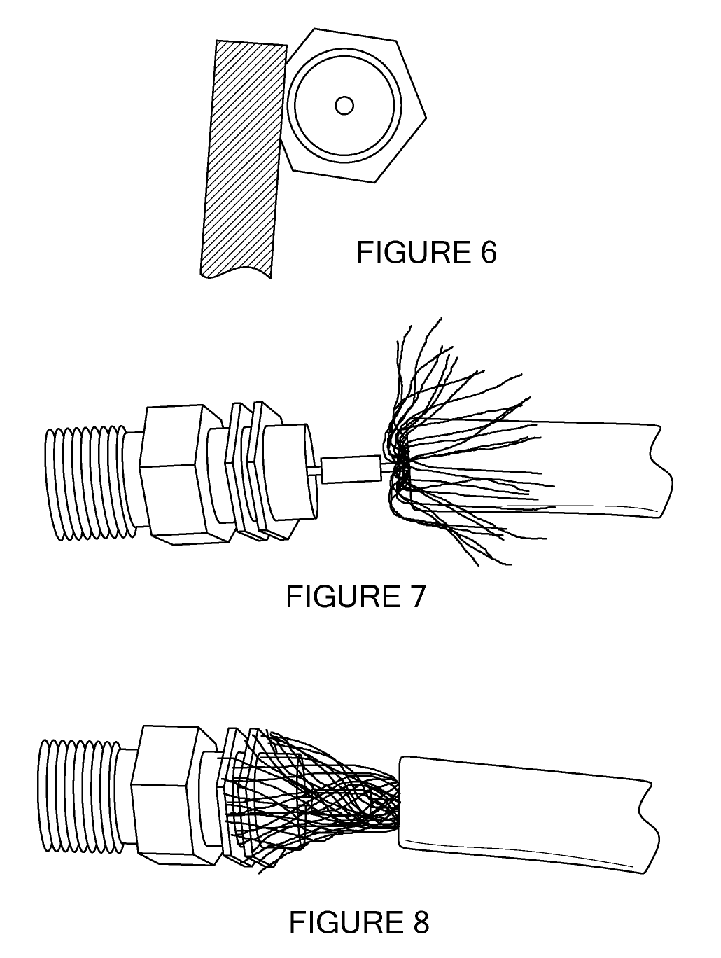

FIG. 7 illustrates the stripped cable with braiding 8 bent back and conductor 2 as inserted into connector 14.

FIG. 8 illustrates the braiding 8 as placed over connector 14 in preparation for coupling with the connector.

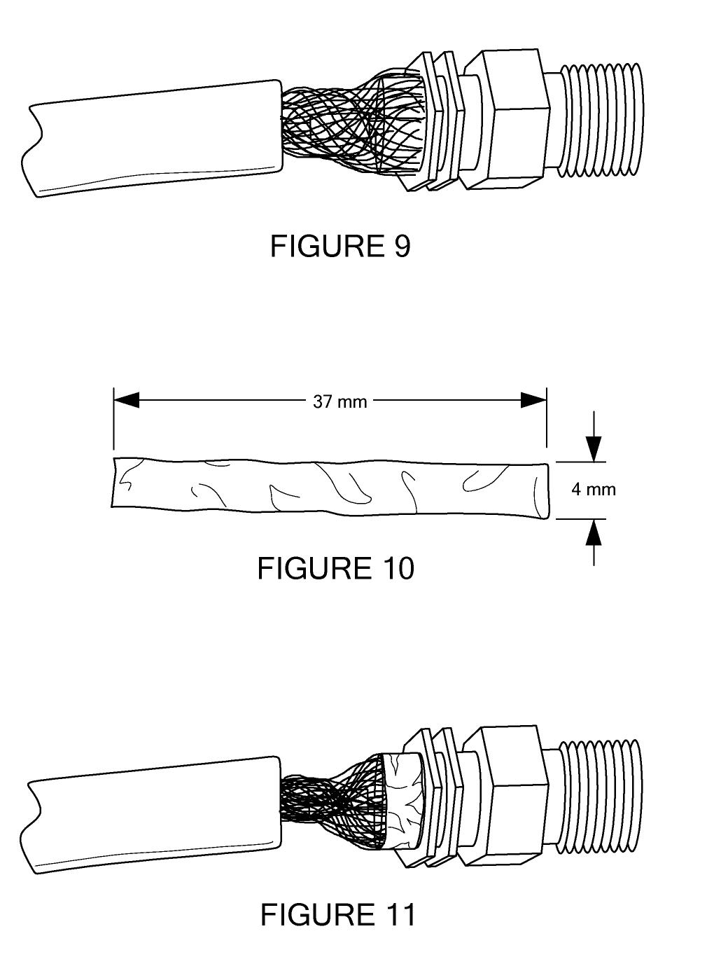

FIG. 9 illustrates the connector rotated and braiding placed all the way around the connector in final preparation for coupling with the connector.

FIG. 10 illustrates a small strip of conductive shielding 1001 to be utilized in coupling the braiding with the connector. In one or more embodiments of the invention, the strip for an F-type connector may be 37 mm by 4 mm, or any other dimension that allows braiding 8 to be coupled with connector 14.

FIG. 11 illustrates small strip of conductive shielding 1001 as wrapped around the braiding that is in contact with the connector.

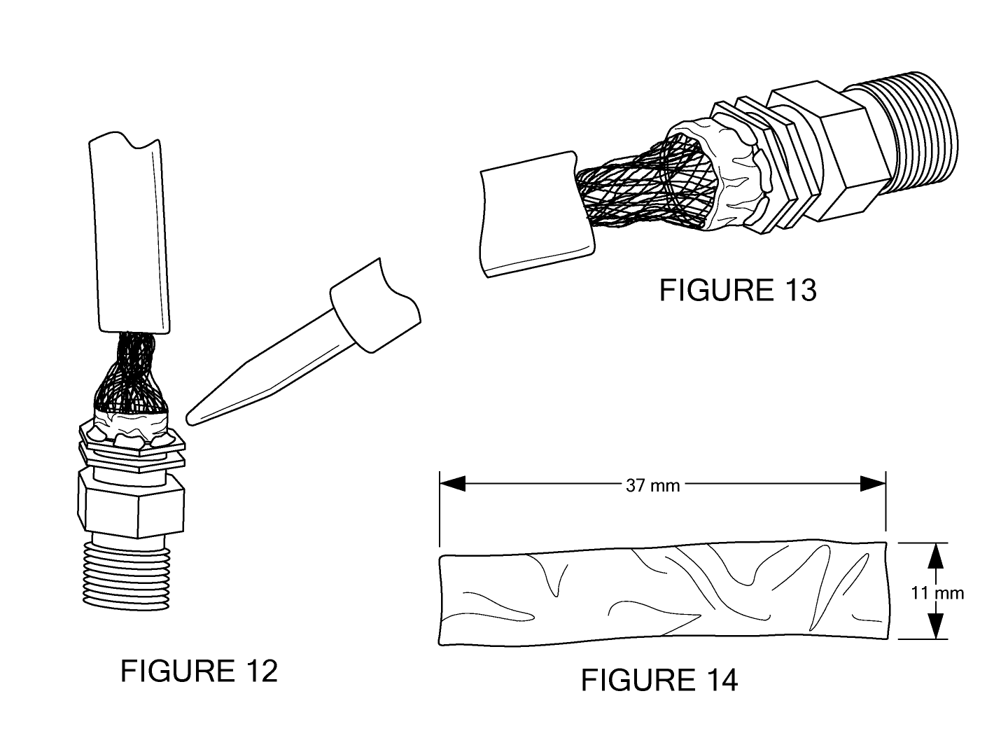

FIG. 12 illustrates small strip of conductive shielding 1001 as soldered to the connector, therein binding the braiding to connector 14. A soldering iron 1201 may be utilized to solder small strip of conductive shielding 1001 to braiding 8 and connector 12.

FIG. 13 illustrates the small strip of conductive shielding as soldered in a perspective view.

FIG. 14 illustrates larger strip of conductive shielding 1401 to be utilized to shield remainder of the braiding. In one or more embodiments of the invention, the larger strip for an F-type connector may be 37 mm by 11 mm, or any other dimension that allows braiding 8 to be covered with conductive material so as to provide improved shielding, higher conductivity of the shielding and to maintain the characteristic impedance of the cable.

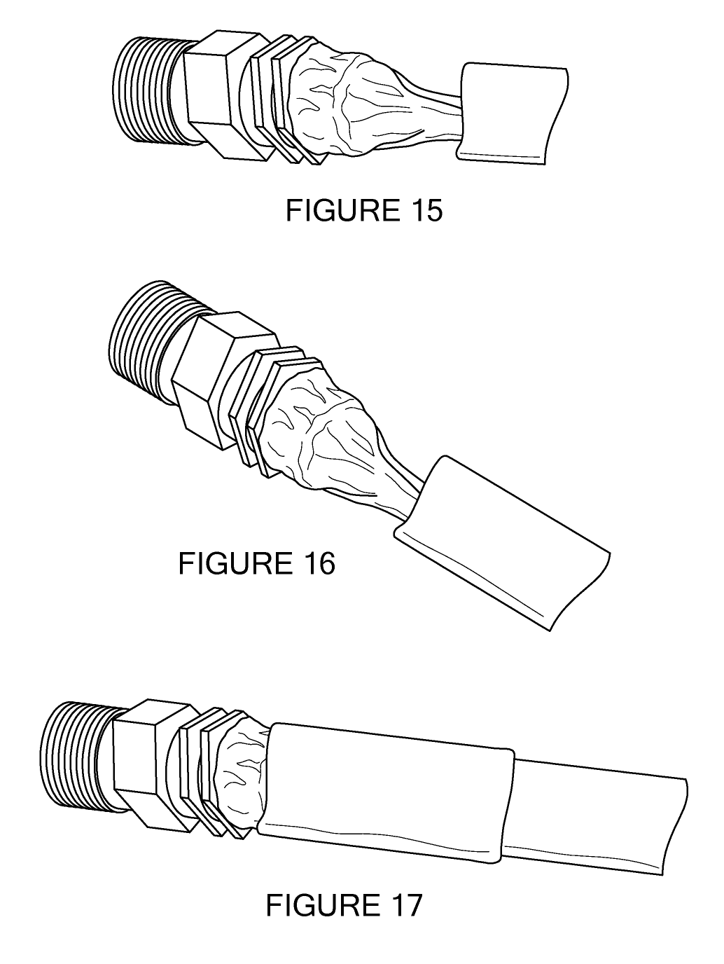

FIG. 15 illustrates larger strip of conductive shielding 1401 wrapped around the braiding and small conductive shielding. The larger strip of conductive shielding 1401 can be wrapped around the braiding and small conductive shielding, and/or soldered or electrically coupled in any other manner as desired.

FIG. 16 illustrates the connector rotated and the larger strip of shielding as placed all the way around the connector.

FIG. 17 illustrates the larger strip of conductive shielding as covered with overmold 1701 material covering larger strip of conductive shielding 1401. Any type of protective material may be utilized for overmold 1701 that allows for protection of the various shields as shown in the previous figures and that reside underneath overmold 1701.

While the invention herein disclosed has been described by means of specific embodiments and applications thereof, numerous modifications and variations could be made thereto by those skilled in the art without departing from the scope of the invention set forth in the claims.

What is claimed is:

1. A thin format crush resistant electrical cable comprising:
at least one bundle, wherein said at least one bundle comprises
a central conductor;
an insulator or dielectric encapsulating said central conductor;
a shielding encapsulating said insulator;
wherein said central conductor, insulator or dielectric and shielding are concentrically aligned as a cylinder with a circular cross section;
a jacket encapsulating said at least one bundle, wherein with respect to a cross-section of said jacket, a height of said jacket is smaller than a width of said jacket; and,
wherein a width of said at least one bundle is less than half of said width of said jacket.

2. The thin format crush resistant electrical cable of claim 1, wherein a ratio of said height and said width is between ⅓ and 1/10.

3. The thin format crush resistant electrical cable of claim 1, wherein said shielding comprises at least one foil shield layer and at least one braiding layer.

4. The thin format crush resistant electrical cable of claim 1 further comprising:
a strip of conductive material; and,
an end connector coupled with the strip of conductive material wherein said shielding is also coupled with said strip of conductive material.

5. The thin format crush resistant electrical cable of claim 1 comprising:
a conductive shrink wrap; and,
an end connector coupled with the conductive shrink wrap wherein said shielding also coupled with said conductive shrink wrap.

6. The thin format crush resistant electrical cable of claim 1 wherein all of said at least one bundle is configured to enable a 180 degree bend in said thin format crush resistant electrical cable.

7. The thin format crush resistant electrical cable of claim 1 wherein all of said at least one bundle is configured to enable a bending radius as low as equal to said height or width of said jacket.

8. The thin format crush resistant electrical cable of claim 1 further comprising:
at least one wire separate from said at least one bundle wherein said at least one wire is not a coaxial conductor and wherein said at least one wire may hold a direction imparted through an external force to form fit said thin format crush resistant electrical cable in a desired direction or wherein said at least one wire is a conductive wire or wherein said at least one wire is both conductive and configured to form fit said desired direction.

9. The thin format crush resistant electrical cable of claim 1 further comprising:
a connector coupled with said central conductor and said shielding;
a small strip of conductive shielding wherein said small strip of conductive shielding couples said shielding to said connector; and,
a larger strip of conductive shielding wherein said larger strip of conductive shielding overlays and encapsulates said small strip of conductive shielding and said shielding separately extended or coupled and said larger strip is separately extended over or coupled to said shielding in a position further distant from said connector than said small strip.

10. A thin format crush resistant electrical cable comprising:
at least one bundle, wherein said at least one bundle comprises
a central conductor;
an insulator or dielectric encapsulating said central conductor;
a shielding encapsulating said insulator;
wherein said central conductor, insulator or dielectric and shielding are concentrically aligned as a cylinder with a circular cross section;
a jacket encapsulating said at least one bundle, wherein with respect to a cross-section of said jacket, a height of said jacket is smaller than a width of said jacket;
wherein a width of said at least one bundle is less than half of said width of said jacket;
a connector coupled with said central conductor and said shielding;
a small strip of conductive shielding wherein said small strip of conductive shielding couples said shielding to said connector; and,
a larger strip of conductive shielding wherein said larger strip of conductive shielding encapsulates said small strip of conductive shielding and said shielding.

11. The thin format crush resistant electrical cable of claim 10, wherein a ratio of said height and said width is between ⅓ and 1/10.

12. The thin format crush resistant electrical cable of claim 10, wherein said shielding comprises at least one foil shield layer and at least one braiding layer.

13. The thin format crush resistant electrical cable of claim 10 further comprising:
a strip of conductive material; and,
an end connector coupled with the strip of conductive material wherein said shielding is also coupled with said strip of conductive material.

14. The thin format crush resistant electrical cable of claim 10 comprising:
a conductive shrink wrap; and,
an end connector coupled with the conductive shrink wrap wherein said shielding also coupled with said conductive shrink wrap.

15. The thin format crush resistant electrical cable of claim 10 wherein all of said at least one cylindrical bundle is configured small enough in diameter to enable a 180 degree bend in said thin format crush resistant electrical cable.

16. The thin format crush resistant electrical cable of claim 10 wherein all of said at least one cylindrical bundle is configured small enough in diameter to enable a bending radius as low as said height or width of said jacket.

17. The thin format crush resistant electrical cable of claim 10 further comprising:
at least one wire separate from said at least one bundle wherein said at least one wire is not a coaxial conductor.

18. The thin format crush resistant electrical cable of claim 10 further comprising:
at least one wire separate from said at least one bundle wherein said at least one wire is not a coaxial conductor and wherein said at least one wire may hold a direction imparted through an external force to form fit said thin format crush resistant electrical cable in a desired direction or wherein said at least one wire is a conductive wire or wherein said at least one wire is both conductive and configured to form fit said desired direction.
